(19) United States
(12) Patent Application Publication
(10) Pub. No.: US 2025/0187949 A1
(43) Pub. Date: Jun. 12, 2025

(54) SEAWATER-FED REVERSE-OSMOSIS DESALINATION PLANT

(71) Applicant: Longitude 123, Inc., Ventura, CA (US)

(72) Inventor: Mark Steffy, Ojai, CA (US)

(21) Appl. No.: 18/972,263

(22) Filed: Dec. 6, 2024

Related U.S. Application Data
(60) Provisional application No. 63/606,892, filed on Dec. 6, 2023.

(51) Int. Cl. C02F 1/44; B01D 61/02; B01D 61/04; B01D 61/08; B01D 61/12; C02F 1/00; C02F 103/08

(52) U.S. Cl. CPC C02F 1/441; B01D 61/025; B01D 61/04; B01D 61/08; B01D 61/12; C02F 1/004; C02F 1/008; B01D 2313/22; B01D 2313/702; C02F 2103/08; C02F 2201/008; C02F 2209/008

(57) ABSTRACT

A desalination system includes a watertight tank built into a barge to house reverse-osmosis tubes and flooded with cooling water or fluid a closed-loop water or a fluid circulation system that circulates water or fluid inside the watertight tank to cool the reverse-osmosis tubes and transfer the heat to a seawater radiator mounted on the exterior of the barge to cool the cooling water or fluid; a reverse-osmosis system consisting of a seawater feed pump sucking in seawater through wedge wire screens attached to an inlet or inlets in the hull of the barge, and pumping that water into a plurality of reverse-osmosis tubes housed within the watertight tank and configured to process the seawater passing through the reverse-osmosis membrane to freshwater water stream and a brine water stream; and a high-density polyethylene (HDPE) pipeline.

### TECHNICAL FIELD

This application claims priority under 35 U.S.C. § 119 (e) to U.S. Provisional Patent Application No. 63/606,892 filed Dec. 6, 2023. This provisional patent application is hereby incorporated by reference in its entirety.

This disclosure relates generally to water desalinization devices and processes. More specifically, this disclosure relates to a seawater-fed reverse-osmosis desalination plant.

### BACKGROUND

California communities and their potable water purveyors are required by the State of California's California Water Plan to diversify their water portfolios to include potable water obtained through desalination of brackish groundwater or raw seawater. Future California coastal desalination facilities using raw seawater must be “pinpoint” operations to limit the potential impacts to marine wildlife from the seawater suctions and have minimal impacts on coastal resources.

### SUMMARY

This disclosure provides a seawater-fed reverse-osmosis desalination plant.

In a first embodiment, a floating desalination plant includes a barge configured to anchor to a seabed and a desalination system configured to desalinate seawater. The desalination system includes a watertight tank built into the barge to house the reverse-osmosis tubes and flooded with cooling water or fluid; a closed-loop water or a fluid circulation system that circulates water or fluid inside the watertight tank to cool the reverse-osmosis tubes and transfer the heat to a seawater radiator mounted on the exterior of the barge to cool the cooling water or fluid; a reverse-osmosis system consisting of a seawater feed pump sucking in seawater through wedge wire screens attached to an inlet or inlets in the hull of the barge, and pumping that water into a plurality of reverse-osmosis tubes housed within the watertight tank and configured to process the seawater passing through the reverse-osmosis membrane to freshwater water stream and a brine water stream; and a high-density polyethylene (HDPE) pipeline, electrical cable and fiber optic cable arranged in the HDD boring to transport the produced freshwater to shore, grid electrical power to the barge, and internet connectivity to enable remote operation of the desalination plant via one or more supervisory control and data acquisition (SCADA) systems or similar remote machinery operating software and equipment.

In a second embodiment, a seabed monopile system includes a reinforced concrete base, a monopile coupled to the reinforced concrete base and including a desalination system configured to desalinate seawater, and a high-density polyethylene (HDPE) pipeline. The desalination system includes a watertight tank built into the monopile to house the reverse-osmosis tubes and a closed-loop water or a fluid circulation system that circulates water or fluid inside the watertight tank to cool the reverse-osmosis tubes and transfer the heat to a seawater radiator mounted on the exterior of the monopile to cool the cooling water or fluid; a reverse-osmosis system consisting of a seawater feed pump sucking in seawater through wedge wire screens attached to an inlet or inlets in the hull of the monopile, and pumping that water into a plurality of reverse-osmosis tubes housed within the watertight tank and configured to process the seawater passing through the reverse-osmosis membrane to freshwater water stream and a brine water stream; and a high-density polyethylene (HDPE) pipeline, electrical cable and fiber optic cable arranged in the HDD boring to transport the produced freshwater to shore, grid electrical power to the barge, and internet connectivity to enable remote operation of the desalination plant via SCADA or similar remote machinery operating software and equipment.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1 and 2 illustrate an example floating desalination plant in accordance with this disclosure;

FIGS. 3 through 9 illustrate an example seabed monopile desalination plant in accordance with this disclosure;

FIG. 10 illustrates an example of a barge-based reverse-osmosis system in accordance with this disclosure; and

FIG. 11 illustrates an example of a monopile-based reverse-osmosis system in accordance with this disclosure.

### DETAILED DESCRIPTION

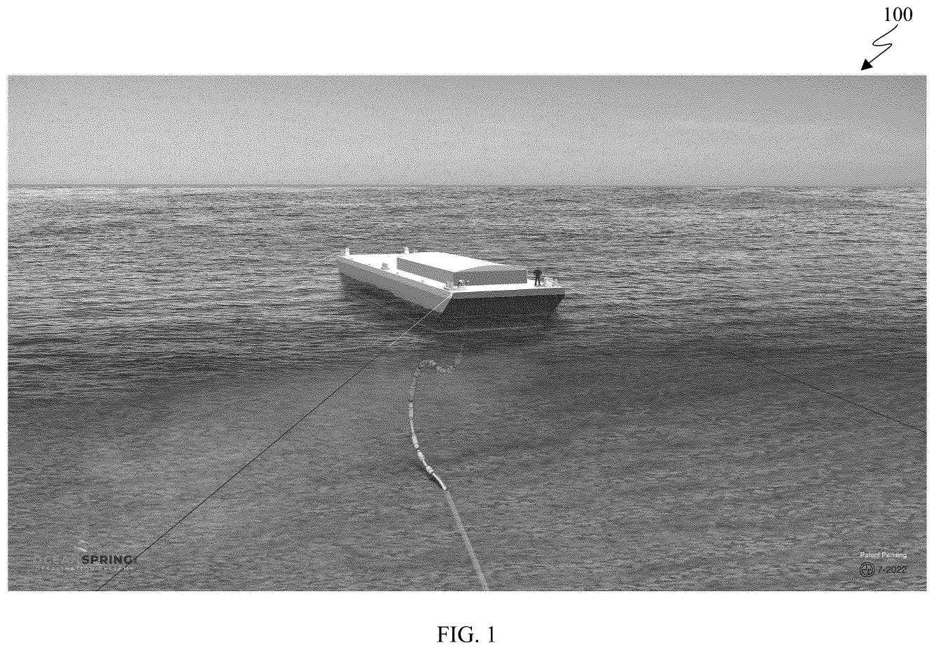

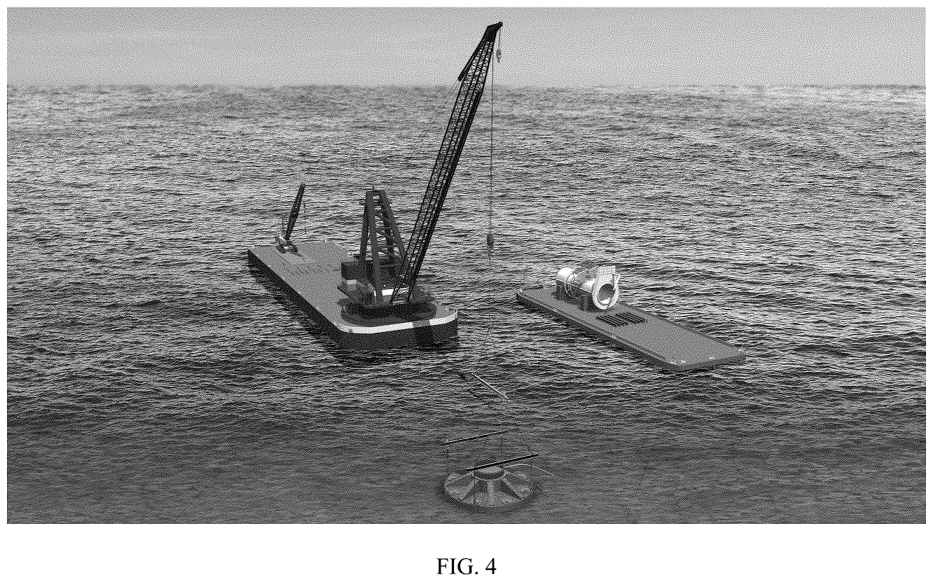

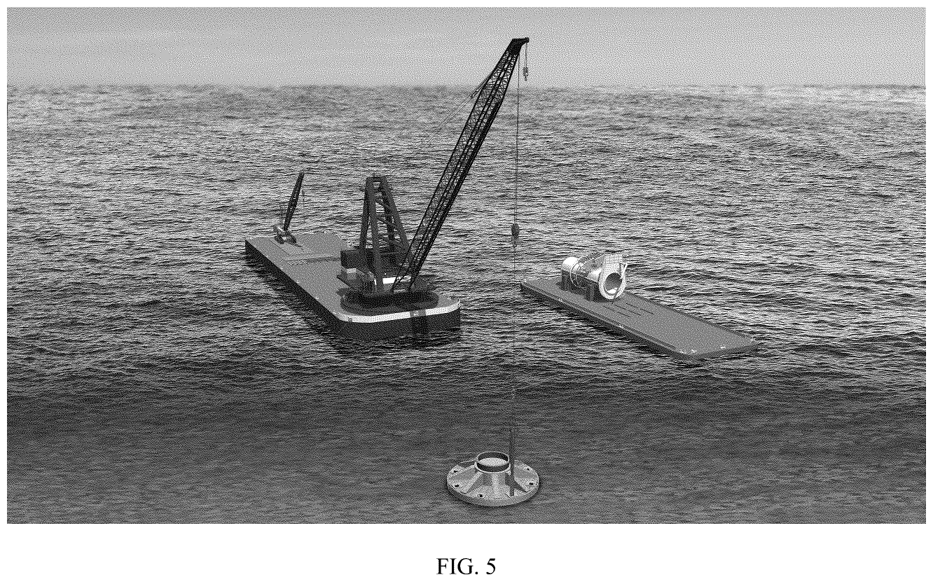

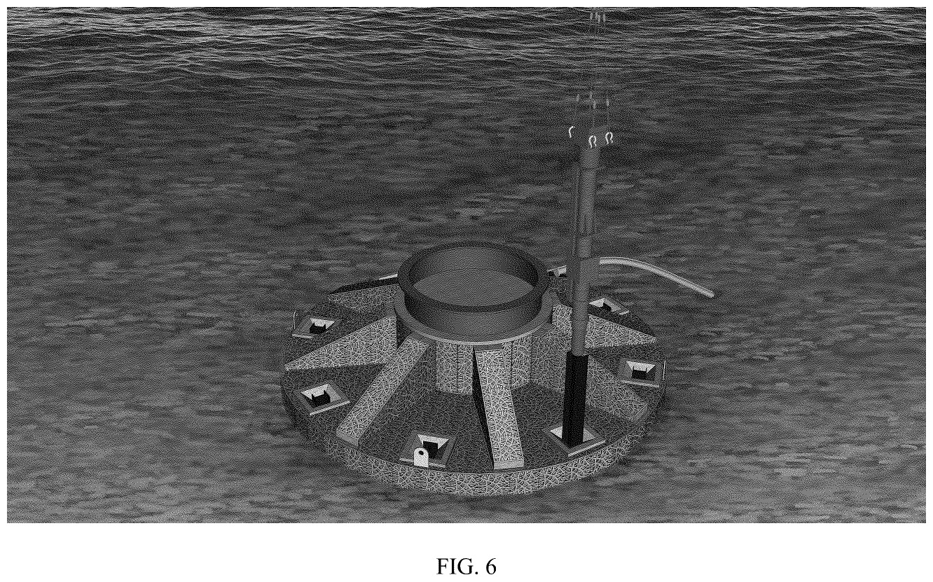

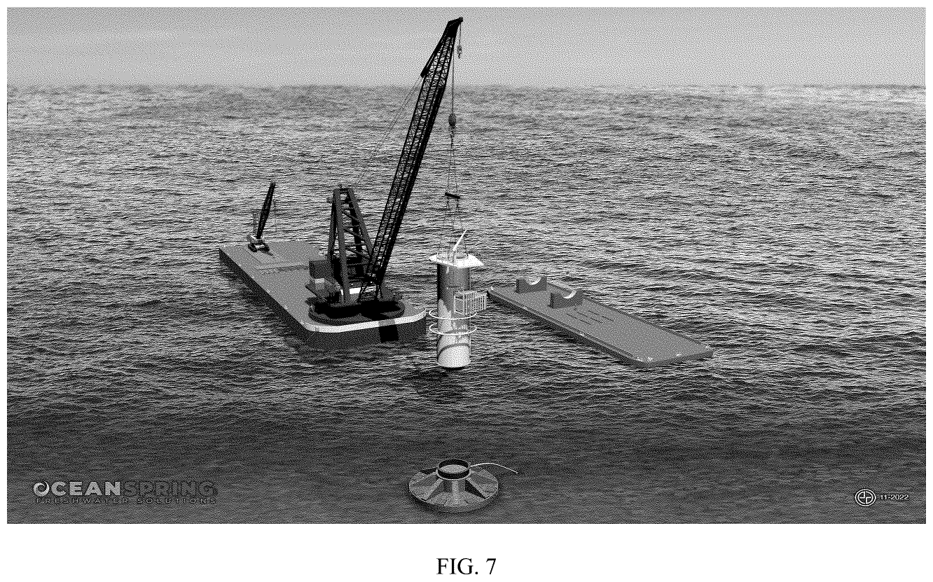

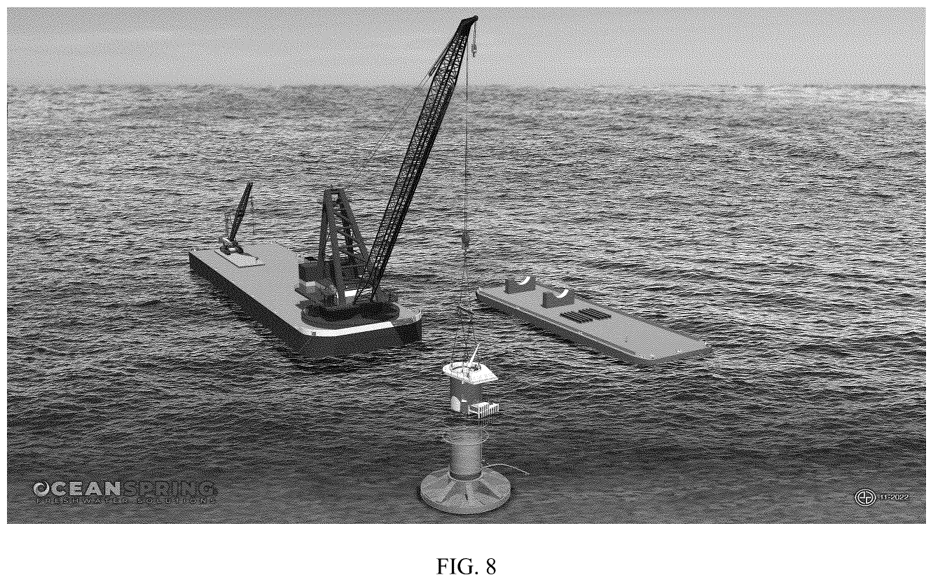

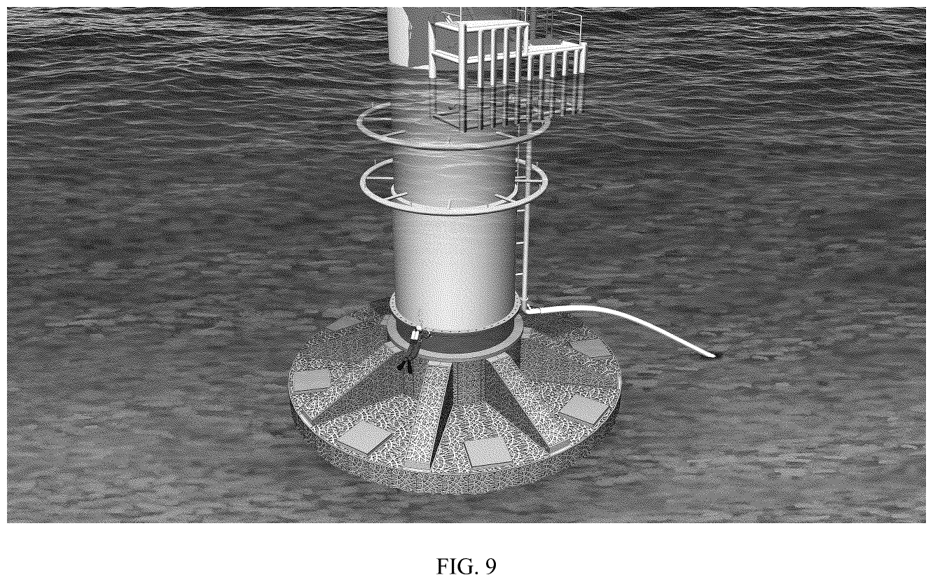

FIGS. 1 through 11, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

Typically, conventional onshore coastal desalination plants use at least one pump to suck raw seawater through a pipeline laid on or under the seafloor from its offshore termination on the seafloor to the onshore desalination plant, or to suck brine water from slant wells drilled from the coastline and extending out at an angle under the seafloor where they terminate several hundred feet under the seafloor. The water from either of these sources feeds the reverse-osmosis process at the heart of the desalination plant. These sources are typically known as the “intake”

The intake or feedwater is then pressed into the reverse-osmosis tubes on one side of the reverse-osmosis membrane and a portion of the feedwater passes through the reverse-osmosis membrane as freshwater. Heat is generated as a by-product of the reverse-osmosis process. The remaining water in the reverse-osmosis tubes increase in salinity and this brine water is discharged through a submarine pipeline that terminates offshore on the seafloor in a specially designed diffuser. The brine water is saltier, and therefore heavier, than the ambient seawater and has the capacity to kill seafloor invertebrates near the outfall's diffuser as the brine water is discharged out of the diffuser and falls through the water column to the surrounding seafloor.

This application provides for two basic concepts. A first concept is a barge-based (floating) desalination plant and the other is a seafloor-based “monopile” desalination plant. Both concepts incorporate innovative technical solutions to unique environmental and regulatory challenges that are encountered when designing, environmental permitting, and constructing desalination plants.

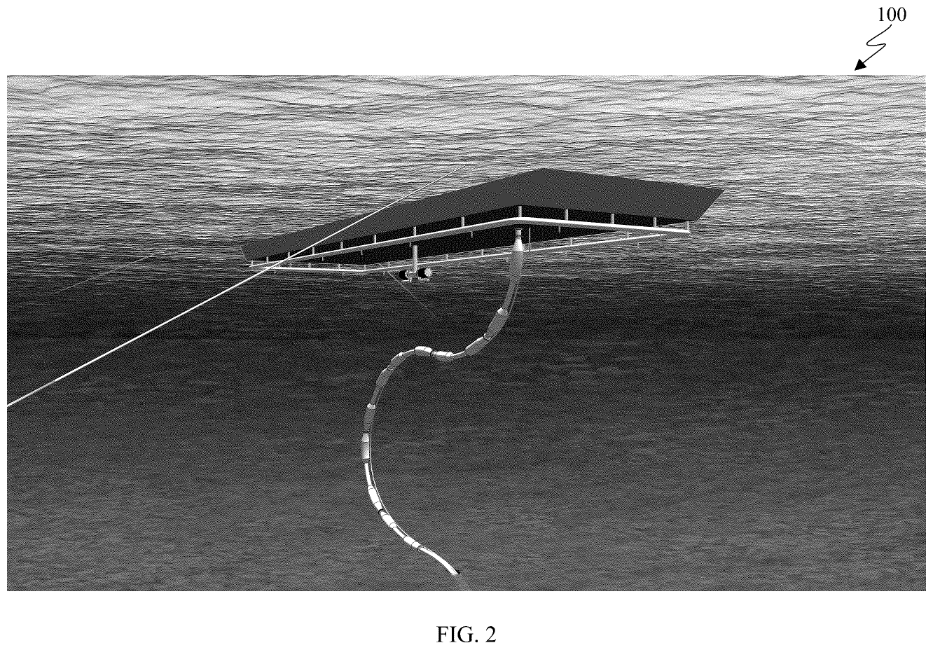

FIGS. 1 and 2 illustrate an example floating desalination plant 100 in accordance with this disclosure. The embodiment of the floating desalination plant 100 illustrated in FIGS. 1 and 2 are for illustration only. FIGS. 1 and 2 do not limit the scope of this disclosure to any particular implementation of a desalination plant.

The floating desalination plant 100 can be constructed and mobilized using existing barges to be mobilized and brought online quickly (estimated at 12 to 18 months). An existing barge can be retrofitted with the desalination system to form the floating desalination plant 100.

The floating desalination plant 100 could be mobilized as droughts reach emergency status and as such the environmental permitting may be performed “after-the-fact”. The floating desalination plant 100 could be an interim solution while the monopile systems 200 are being fabricated, permitted, and installed.

As shown in FIGS. 1 and 2, the floating desalination plant 100 can be anchored in a body of seawater to desalinate the seawater. Existing deck barges or materials barges varying in size, for example from approximately 100-feet to 400-feet depending on the desire capacity of a given floating desalination plant 100, can be altered to house a horizontal reverse-osmosis desalination system. Production from a floating desalination plant 100, and associated desalination plant capacity, may range between 500 and 5,000 acre feet of water per year (one acre foot=325,851 gallons). The floating desalination plants 100 can be anchored in approximately 60-feet of water and approximately 5,000 to 7,000 feet offshore of a coastline.

The floating desalination plant 100 can filter seawater through intakes with wedge-wire screens. The brine water generated by the reverse-osmosis process of the floating desalination plant 100 can be discharged through a pipe diffuser system attached to a bottom perimeter of the exterior of the barge. This is a unique feature in that the brine can be discharged near the surface of the ocean (just underneath the barge) and can diffuse through the entire 60-foot water column almost entirely before reaching the seafloor.

Using horizontal directional drilling (HDD), a hole can be bored under the seafloor from somewhere above the shoreline and exit the seafloor underneath the floating desalination plant 100. A high-density polyethylene (HDPE) pipeline and a submarine power cable of appropriate capacity can pass through this bored hole. The offshore end of the HDPE pipeline can be laid on the seafloor and connected to the floating desalination plant 100 through a string of flexible submarine cargo hoses. This pipeline can be used to convey the produced freshwater from the barge to shore and connected to private or municipal freshwater systems. The power cable can also be connected to the floating barge and can be used to provide existing grid electrical power to the floating desalination plant 100. A fiber optic cable can be integrated into the submarine power cable to connect the floating desalination plant 100 to the internet onshore so that the barge can be operated remotely through a SCADA system.

In certain embodiments, multiple floating desalination plant 100 can be clustered around and manifolded to a single pipeline so that all the desalination production can be transported to shore through a single pipeline. In certain embodiments, a first pipeline could be used for desalination production and a second pipeline could be used for power cable and fiber optic cables for the multiple floating desalination plant 100.

Pushing seawater through the reverse-osmosis membranes, which are typically housed in membrane tubes, can generate significant heat that may damage the reverse-osmosis membranes if not properly dissipated. Conventional onshore desalination plants place significant open space between adjacent reverse-osmosis tubes to counter this phenomenon, which is problematic on a floating desalination plant 100 where space is at a premium. To remedy this challenge, the floating desalination plant 100 can use a watertight tank inside the body of the barge to house the reverse-osmosis tubes and water or other fluids pumped through one or more inlets and outlets to a seawater radiator system disposed on the hull of the floating desalination plant 100 to dissipate heat and circulate cooled water or other fluid back to the watertight tank housing the reverse-osmosis tubes.

Although FIGS. 1 and 2 illustrate an example floating desalination plant 100, various changes may be made to FIGS. 1 and 2. For example, the number and placement of various components of the floating desalination plant 100 can vary as needed or desired. In addition, the floating desalination plant 100 may be used in any other suitable desalination process and is not limited to the specific processes described above.

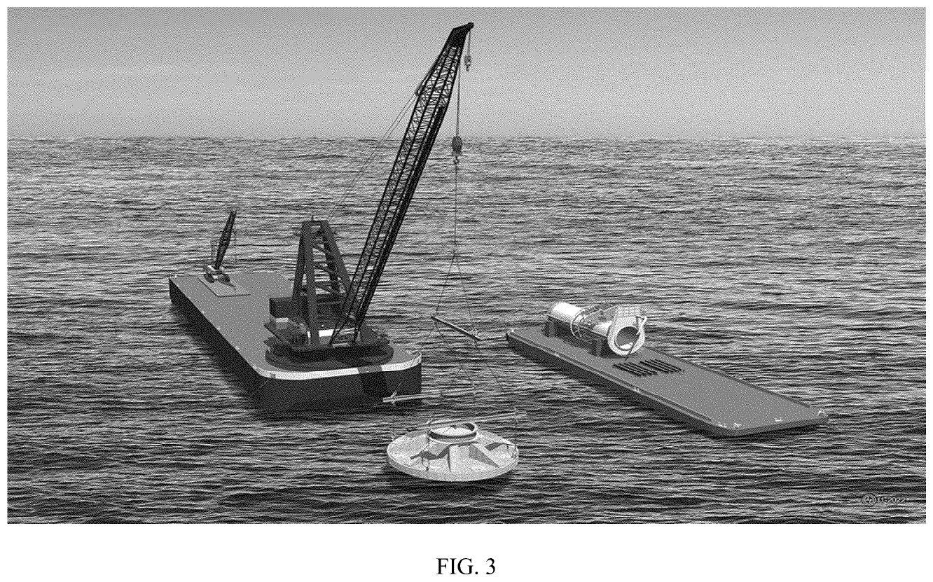

FIGS. 3 through 9 illustrate an example seabed monopile desalination plant 200 in accordance with this disclosure. The embodiments of the example seabed monopile desalination plant 200 illustrated in FIGS. 3 through 9 are for illustration only. FIGS. 3 through 9 do not limit the scope of this disclosure to any particular implementation of a desalination plant.

The seabed monopile desalination plant 200 may take longer to produce or install and may require additional permitting before installation. The seabed monopile desalination plant 200 can be a semi-permanent structure but easily replaced or decommissioned and removed at the end of a usable life. The life expectancy of the seabed monopile desalination plant 200 can be estimated around 30 years, not including regular maintenance, such as reverse-osmosis membranes that may need to be replaced, for example approximately every 5 years.

The seabed monopile desalination plant 200 can include a reinforced concrete base and a large diameter vertical steel tube. The reinforced concrete base can be anchored to the seafloor with steel piling driven through the base. The large diameter vertical steel tube can be fastened to the pre-installed reinforced concrete base. For example, the large diameter vertical steel tube can be manufactured approximately 25 feet in diameter and 90 feet in overall height, depending on the water depth at a given offshore site and maximum anticipated sea states. The capacity of a seabed monopile desalination plant 200 of these dimensions may be approximately 2,000 to 3,000-acre feet per year. The seabed monopile desalination plant 200 can be anchored in approximately 60-feet of water and approximately 5,000 to 7,000 feet offshore of a coastline.

The seabed monopile desalination plant 200 has an intake that can filter seawater through wedge-wire screens. Alternatively, seabed monopile desalination plant 200 can include slant-type wells to obtain feed water from shallow seawater aquafers located approximately 400 feet below the seafloor. The slant-type wells can be drilled through the center of the monopile and base using sonic drilling technology.

Similar to the floating desalination plant 100, seabed monopile desalination plant 200 can discharge brine through circular diffuser pipes attached to an exterior of the monopile tube just under the water surface to dilute the brine into the ambient seawater before it reaches the seafloor.

An HDPE pipeline can be used to transport produced freshwater to shore and run a power cable to power the seabed monopile desalination plant 200, similar to the floating desalination plant 100. A fiber optic cable can be integrated into the submarine power cable to connect the monopile to the internet onshore so that the seabed monopile desalination plant 200 can be operated remotely through a SCADA system.

Multiple seabed monopile desalination plants 200 can be clustered around and manifolded to a single pipeline so that all the desalination production can be transported to shore through a single pipeline. In certain embodiments, a first pipeline could be used for desalination production and a second pipeline could be used for power cable and fiber optic cables for the multiple floating desalination plant 100.

In certain embodiments, one or more floating desalination plant 100 and one or more seabed monopile desalination plants 200 can be clustered around and manifolded to a single pipeline so that all the desalination production can be transported to shore through a single pipeline. In certain embodiments, a first pipeline could be used for desalination production and a second pipeline could be used for power cable and fiber optic cables for the multiple floating desalination plant 100. For example, a specified amount of seabed monopile desalination plants 200 can be implemented to manage an average amount or median amount of water desalination for a community and floating desalination plants 100 can be utilized for seasonal usage that exceeds the average amount or median amount. Floating desalination plants 100 could also be utilized for unexpected or emergency surges. Floating desalination plants 100 could also be utilized during maintenance periods of seabed monopile desalination plants 200.

Steel piling-to-reinforced concrete base connections using high strength underwater epoxy grout can be used to anchor the base of seabed monopile desalination plants 200.

Like the floating desalination plants 100, the seabed monopile desalination plants 200 can include a watertight water of fluid filled tank inside the body of the monopile to house the reverse-osmosis membrane tubes. Water or fluid can be circulated in a closed-loop system through the flooded watertight tank to cool the membrane tubes and then through a seawater radiator system mounted on the exterior of the monopile to transfer the heat from the circulating water or fluid to the ocean.

Although FIGS. 3 through 9 illustrate an example seabed monopile desalination plant 200, various changes may be made to FIGS. 3 through 9. For example, the number and placement of various components of the seabed monopile desalination plant 200 can vary as needed or desired. In addition, the seabed monopile desalination plant 200 may be used in any other suitable desalination process and is not limited to the specific processes described above. The number, sizes, and elevations of the placement of the seabed monopile desalination plant 200 intakes, freshwater discharge port/s, diffuser pipe/s and cooling radiator/s can vary as needed or desired.

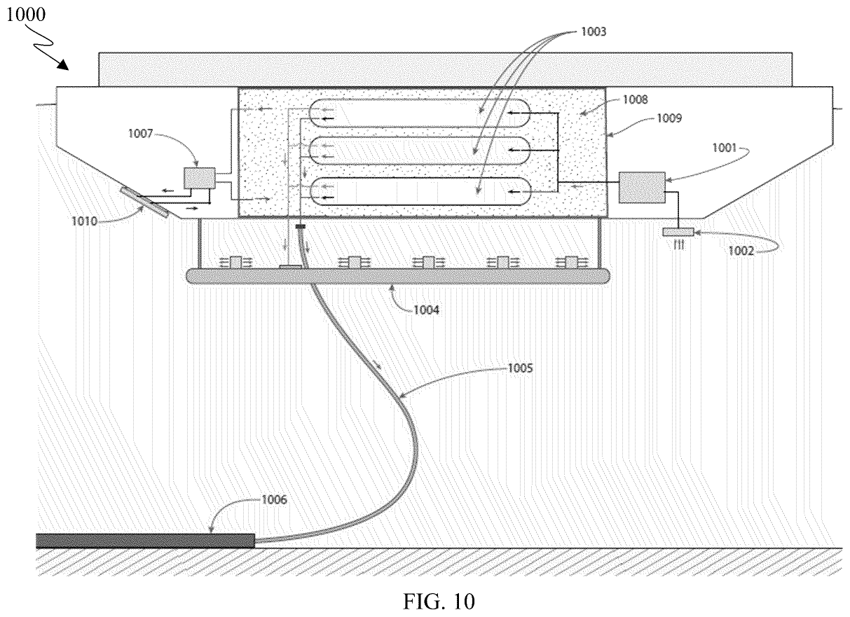

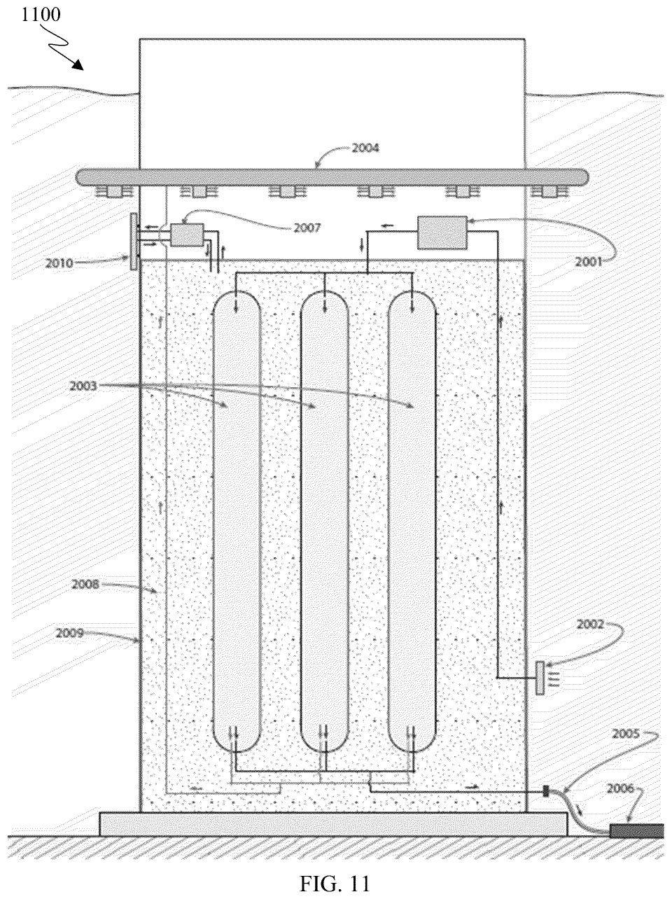

FIG. 10 illustrates an example barge-based desalination plant 1000 in accordance with this disclosure. FIG. 11 illustrates an example monopile-based desalination plant 1100 in accordance with this disclosure. The embodiment of the barge-based desalination plant 1000 illustrated in FIG. 10 and the monopile-based desalination plant 1100 illustrated in FIG. 11 are for illustration only. FIGS. 10 and 11 do not limit the scope of this disclosure to any particular implementation of a desalination plant.

As shown in FIGS. 10 and 11, the reverse-osmosis systems 1000 and 1100 can be implemented in either the floating desalination plant 100 or the seabed monopile desalination plant 200. The desalination systems 1000 and 1100 can include at least one reverse-osmosis seawater feed pump 1001 and 2001, a plurality of wedge wire intakes 1002 and 2002, reverse-osmosis membrane tubes 1003 and 2003, a brine water diffuser system 1004 and 2004, a submarine cargo hose jumper 1005 and 2005, fiber optic cable 1006 and 2006, at least one cooling water or fluid circulation pump 1007 and 2007, cooling water or fluid 1008 and 2008, at least one watertight cooling tank 1009 and 2009, and a seawater radiator system 1010 and 2010.

Both the reverse-osmosis system 100 and 200 use electrically powered pumps 1001 and 2001 to in seawater through wedge wire intake screens 1002 and 2002, press that water through the reverse-osmosis tubes 1003 and 2003, discharge the high-saline concentrate of brine water into a diffuser 1004 and 2004 to the ocean, and discharge the produced freshwater through a submarine cargo hose system 1005 and 2005 attached to a buried HDPE pipeline 1006 and 2006 to shore. Both the reverse-osmosis system 100 and 200 use electrically powered pumps 1007 and 2007 to circulate cooling water or fluid 1008/2008, in a closed-loop system, through the watertight compartment(s) 1009 and 2009 that house the reverse-osmosis tubes to cool the tubes, and to circulate that cooling water or fluid through a seawater radiator 1010/20010 mounted on the exterior of the barge 100 or the monopile 200 to transfer the heat from the reverse-osmosis tubes to the ocean.

In certain embodiments, a floating desalination plant includes a barge, a reverse osmosis system, and a high-density polyethylene (HDPE) pipeline with grid-power cable and a fiber optic cable. The floating desalination plant is configured to desalinate seawater and ship freshwater to shore for distribution. The floating desalination plant is based on a barge, and the reverse-osmosis system consists of reverse-osmosis tubes housing reverse-osmosis membranes and submerged in a watertight tank built into the barge and filled with water or fluid that is recirculated through the watertight tank and then passed through a seawater radiator system attached to the exterior bottom of the barge to transfer the reverse-osmosis generated heat to the ocean. An intake pipe also attached to the bottom of the barge serves as the suction for electrically powered pumps mounted on the barge that push seawater through the reverse-osmosis tubes where the sea water is separated into a freshwater stream and a brine stream. The brine stream is directed to a brine diffuser system mounted on the bottom of the barge to discharge and diffuse the brine generated in the reverse-osmosis process back into the ocean. The freshwater stream coming out of the reverse-osmosis process is pumped to shore through a combination of a flexible submarine cargo hose system that connects the reverse-osmosis system on the barge to a buried HDPE pipeline termination on the seafloor underneath the floating barge. The HDPE pipeline transports the freshwater to shore, where the reverse-osmosis freshwater is remineralized and transported to private or municipal freshwater systems. The HDPE pipeline is installed from its onshore initiation point to its termination on the seafloor underneath the floating barge in a horizontal directionally drilled (HDD) boring large enough to accommodate the HDPE pipeline, an electrical power cable providing grid power to the desalination plant, and a fiber optic cable to provide internet connectivity to the desalination plant to operate the desalination plant remotely using SCADA hardware and software.

In certain embodiments, a monopile-based desalination plant includes a reinforced concrete base, a steel monopile coupled to the reinforced concrete base, and a reverse osmosis system installed inside the steel monopile. The monopile-based desalination plant is configured to desalinate seawater and includes the monopile and its base with a reverse-osmosis system that consists of horizontal or vertical tubes housing reverse-osmosis membranes and submerged in a watertight tank built into the monopile and filled with water or fluid that is recirculated through the watertight tank and then passed through a seawater radiator system attached to the exterior bottom of the barge to transfer the reverse-osmosis generated heat to the ocean. One or more intake pipes mounted near the bottom of the monopile serve as the suctions for electrically powered pumps mounted inside the monopile that push seawater through the reverse-osmosis tubes where the seawater is separated into a freshwater stream and a brine stream. The brine stream is directed to a brine diffuser system consisting of rings of pipes encircling the exterior of the monopile near the water surface to discharge and diffuse the brine generated in the reverse osmosis process back into the ocean. The freshwater stream coming out of the reverse-osmosis process is pumped to shore through a flexible submarine cargo hose system that connects the reverse-osmosis system in the monopile to a buried HDPE pipeline that terminates on the seafloor near the monopile base. The HDPE pipeline transports the freshwater to shore, where the reverse-osmosis freshwater is remineralized and transported to private or municipal freshwater systems. The HDPE pipeline is installed from its onshore initiation point to its termination adjacent to the monopile base on the seafloor in a horizontal directionally drilled (HDD) boring large enough to accommodate the HDPE pipeline, an electrical power cable providing grid power to the desalination system in the monopile, and a fiber optic cable to provide internet connectivity to the monopile to operate the desalination plant remotely using SCADA hardware and software.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112 (f) with respect to any of the appended claims or claim elements unless the exact words “means for” or “step for” are explicitly used in the particular claim, followed by a participle phrase identifying a function.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A floating desalination plant comprising:
a barge configured to anchor to a seabed; and
a desalination system configured to desalinate seawater, the desalination system comprising:
a watertight tank built into the barge to house the reverse-osmosis tubes and flooded with cooling water or fluid;
a closed-loop water or a fluid circulation system that circulates water or fluid inside the watertight tank to cool the reverse-osmosis tubes and transfer the heat to a seawater radiator mounted on the exterior of the barge to cool the cooling water or fluid;
a reverse-osmosis system consisting of a seawater feed pump sucking in seawater through wedgewire screens attached to an inlet or inlets in the hull of the barge, and pumping that water into a plurality of reverse-osmosis tubes housed within the watertight tank and configured to process the seawater passing through the reverse-osmosis membrane to freshwater water stream and a brine water stream; and
a high-density polyethylene (HDPE) pipeline, electrical cable and fiber optic cable arranged in the HDD boring to transport the produced freshwater to shore, grid electrical power to the barge, and internet connectivity to enable remote operation of the desalination plant via SCADA or similar remote machinery operating software and equipment.

2. A monopile desalination plant comprising:
a reinforced concrete base; and
a desalination system configured to desalinate seawater, the desalination system comprising:
a watertight tank built into the monopile to house the reverse-osmosis tubes and a closed-loop water or a fluid circulation system that circulates water or fluid inside the watertight tank to cool the reverse-osmosis tubes and transfer the heat to a seawater radiator mounted on the exterior of the monopile to cool the cooling water or fluid;
a reverse-osmosis system consisting of a seawater feed pump sucking in seawater through wedge wire screens attached to an inlet or inlets in the hull of the monopile, and pumping that water into a plurality of reverse-osmosis tubes housed within the watertight tank and configured to process the seawater passing through the reverse-osmosis membrane to freshwater water stream and a brine water stream; and
a high-density polyethylene (HDPE) pipeline, electrical cable and fiber optic cable arranged in the HDD boring to transport the produced freshwater to shore, grid electrical power to the barge, and provide internet connectivity to enable remote operation of the desalination plant via SCADA or similar remote machinery operating software and equipment.
